(19) United States
(12) Patent Application Publication
(10) Pub. No.: US 2011/0161200 A1
(43) Pub. Date: Jun. 30, 2011

(54) Display Device

(75) Inventors: Ronen Carmona, Ramat Gan (IL); Gil Zilhka, Kirit Ono (IL)

(73) Assignee: LIGHT BOOK LTD., Merkaz Tzlil (IL)

(21) Appl. No.: 11/569,057

(22) PCT Filed: Apr. 19, 2005
(86) PCT No.: PCT/IL2005/000404

§ 371 Date: Nov. 13, 2006

(30) Foreign Application Priority Data
May 12, 2004 (IL) 161935

(51) Int. Cl. G06F 21/00; G06Q 30/00; G06Q 20/00

(52) U.S. Cl. 705/27.1; 726/26; 235/381

(57) ABSTRACT

A system comprising an electronic book and a propriety appendage couplable to the electronic book; the electronic book comprising a visual display screen, a data reader, navigational tools and a first section of a unique identification code for identifying the electronic book; the propriety appendage comprising a memory and a second section of unique identification code; such that data in memory of proprietary appendage having second section of unique identification code can only be accessed when proprietary appendage is connected to an electronic book having first section of unique identification code.

### FIELD OF THE INVENTION

The present invention relates to making documents readily available in electronic form, whilst preventing the unauthorized copying thereof, thereby providing security for confidential documentation and/or protecting author's rights.

### BACKGROUND OF THE INVENTION

Since the advent of printing, the amount of written material has grown tremendously. Reproduction costs have dropped and such material has become more widely available than ever before.

It has long been recognised that the authors and formatters of documents deserve protection and/or compensation for their products, and all countries have copyright laws that provide statutory recognition for this right.

However, the costs of reproducing and the availability of reproduction technology are ever dropping, that it is becoming ever easier to illicitly reproduce documentation.

Nowadays, all schools and offices have photocopiers, making duplication of printed material trivial. Indeed many private homes have photocopiers. Where books are sold for more than duplicating costs, or where there is interest in copying only a section of a book, despite national copyright laws, much material is reproduced in ways that do not provide any compensation for the author.

Much text material is available in electronic form and, with scanners being widely available, stored on disk or streamed over the Internet. Indeed, with OCR technology, printed material can be converted into ASCII text and then reformatted or otherwise manipulated. In certain circumstances, “home use” clauses in copyright law make reproduction for personal use perfectly legal. That as may be, although it may be feasible to prosecute commercial duplicators of copyright material, even where illegal it is not practicable to enforce authors rights against individuals making single or small numbers of copies.

One advantage of digital reproduction and distribution of material is the possibility of providing frequent updates. Since encyclopaedias that once took up whole bookcases can be stored on a couple of CD-ROMs, another advantage is the enormous amount of reference material that can be conveniently made available to students and researchers. A third advantage is that where material is distributed electronically, fewer trees are pulped to produce paper. These advantages threaten the authoring and publishing of much material as it is no longer possible to guarantee a return on investment for authors and publishers, even if their work is successful in the sense of widely read.

There is therefore a need for a device and technology with the ease of distribution, compactness and environmental advantages of electronic documents, whilst preventing reproduction or access to the material without paying royalties.

Another problem inherent in electronic documents is that of security. Although encryption and passwords are widely used, electronic documents are all too easily “hacked”.

Electronic books, i.e. browsers for reading electronic documents, are known. Such electronic books suffer the same drawbacks with regard to protecting data that are inherent in other hardware systems including PCs, portables computers, and handheld (palm-top) devices.

The present invention addresses the two issues of effectively preventing unlawful reproduction of electronic documents, i.e. copyright piracy, and also that of data security, preventing unauthorized access to electronic documentation.

### SUMMARY OF THE INVENTION

In a first aspect, the present invention is directed to providing a system comprising an electronic book and a propriety appendage coupleable to said electronic book;

Said electronic book comprising a visual display screen, a data reader, navigational tools and a first section of a unique identification code for identifying said electronic book;
Said propriety appendage comprising a memory and a second section of unique identification code; such that data in memory of proprietary appendage having second section of unique identification code can only be accessed when proprietary appendage is connected to electronic book having first section of unique identification code.

Optionally the proprietary appendage is coupleable to the electronic book via a USB connector.

Preferably, the data in said memory, once written is readable only.

Optionally and preferably, the data in the memory of the proprietary appendage is encrypted by a proprietary encrypting algorithm.

Optionally and preferably, the data in said memory of proprietary appendage is only accessible by using proprietary software only available to authorized electronic books.

Preferably, the electronic book further comprises a processing chip having a routine hardwired therein, that checks for presence of first section of unique identification code within said electronic book and second section of unique identification code within said proprietary appendage, and only after detecting presence of both, and their mutual compatibility, allows displaying of data stored within proprietary appendage.

In one embodiment, the electronic book is a personal computer, first section of unique identification code is a unique serial number of said personal computer, and said proprietary appendage is equipped with a second section of unique identification code that is said unique serial number of said personal computer.

In a second aspect, the present invention is directed to providing an electronic book comprising a visual display screen, a data reader, navigational tools and a first section of a unique identification code for identifying said electronic book, said electronic book for use with a propriety appendage comprising a memory and a second section of unique identification code, such that data in memory of proprietary appendage having second section of unique identification code can only be accessed when proprietary appendage is connected to an electronic book having first section of unique identification code.

In a third aspect, the present invention is directed to providing a propriety appendage comprising a memory and a second section of unique identification code for use with an electronic book comprising a visual display screen, a data reader, navigational tools and a first section of a unique identification code for identifying said electronic book, such that data in memory of proprietary appendage having second section of unique identification code can only be accessed when proprietary appendage is connected to an electronic book having first section of unique identification code.

In a fourth aspect, the present invention is directed to providing a dedicated vending outlet comprising: a display screen, control buttons, a facility for accepting payment, a socket, a link to a remote database and burning software; Said display screen for displaying options to a user; Said control buttons for enabling said user to toggle displays on said display screen, to place order and optionally to select payment means; Said socket for accepting a proprietary appendage of an electronic book as described hereinabove; said link for downloading of data from remote database and said burning software for writing said data to said proprietary appendage.

Optionally, the dedicated vending outlet includes a biometric reader for reading a physical identifying characteristic of the user, such as fingerprints thereof.

Optionally, the dedicated vending outlet includes a magnetic card reader for reading a magnetic card containing details of said user, user's electronic book, purchasing allowance and payment method.

Typically, the dedicated retail outlet somewhat resembles a cash vending machine. Optionally and preferably the dedicated retail outlet is situated on campus.

Typically said data will include study material.

Preferably the dedicated vending outlet will enable updating of said proprietary appendage and/or said electronic book.

In a fifth aspect, the present invention is directed to providing a novel method allowing purchase of data such as study material, for use with said electronic book via a dedicated vending outlet as described hereinabove, comprising the steps of:
(a) Allowing purchaser to input purchase code of electronic book to dedicated vending outlet;
(b) Identifying user;
(c) Offering a range of purchase types offered for purchaser to make selection of desired purchase type;
(d) Offering purchaser a selection of specific purchase options;
(e) Displaying cost of selected purchases;
(f) Offering and accepting authorization of purchase;
(g) Allowing insertion of a proprietary appendage as described hereinabove into socket;
(h) Updating and securing memory of proprietary appendage and
(i) Allowing purchaser to remove proprietary appendage.

To complete installation, it is necessary for purchaser to perform additional step (j) of connecting proprietary appendage to electronic book and implementing installation thereon.

Typically the inputting of the purchase code is via control buttons.

Alternatively, the inputting of purchase code by swiping a magnetic card through magnetic card reader.

Optionally, identifying of user is via biometric identification means such as a fingerprint reader for example.

Typically the range of purchase types including purchase of study material, purchase of upgrade of study material.

Typically, the specific purchase being a unit of study material chosen from a list of study materials. The specific purchase may however, be an update for a unit of study material chosen from a list of updates, or, the specific purchase may be an upgrade for the electronic book.

### BRIEF DESCRIPTION OF THE DRAWINGS

For a better understanding of the invention and to show how it may be carried into effect, reference will now be made, purely by way of example, to the accompanying drawings.

It is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, structural details of embodiments of the invention are provided by way of example only, and the description taken with the drawings make apparent to those skilled in the art how the several forms of the invention may be embodied in practice. In the accompanying drawings:

FIG. 1 is an isometric projection of an exemplary system in accordance with a first embodiment of the present invention, showing a lid for protecting the screen of the electronic book.

FIG. 2 is an isometric projection of the electronic book of the embodiment of FIG. 1, showing how the lid becomes a stand for comfortable viewing of the screen thereof.

FIG. 3 is an isometric projection of a specific embodiment of the electronic book of the invention wherein the functional components thereof are preferably fully and easily separable from the front and back panels thereof.

FIG. 4 is a flowchart illustrating the method of inputting data into the memory of the appendage.

FIG. 5 is a flowchart showing security measures for protecting data in said memory, and preventing unauthorized access thereto.

FIG. 6 shows a particularly electronic book system comprising a master electronic book equipped with a transmitter and a plurality of slave electronic books equipped with receivers.

FIG. 7 is a flowchart illustrating exemplary methods of ordering content for burning into a memory of the appendage for subsequent display on an electronic book.

FIG. 8 schematically shows how data may be downloaded from a data archive via a terminal and saved onto a memory in a memory-writing device for subsequent insertion into a proprietary appendage.

FIG. 9 schematically shows a dedicated vending outlet for downloading content to proprietary appendages; such a vending outlet would typically be conveniently located on a college campus or within a school building.

FIG. 10 is a flow diagram describing method of downloading content to a proprietary appendage via a dedicated vending outlet such as that shown in FIG. 9.

### DETAILED DESCRIPTION OF THE EMBODIMENTS

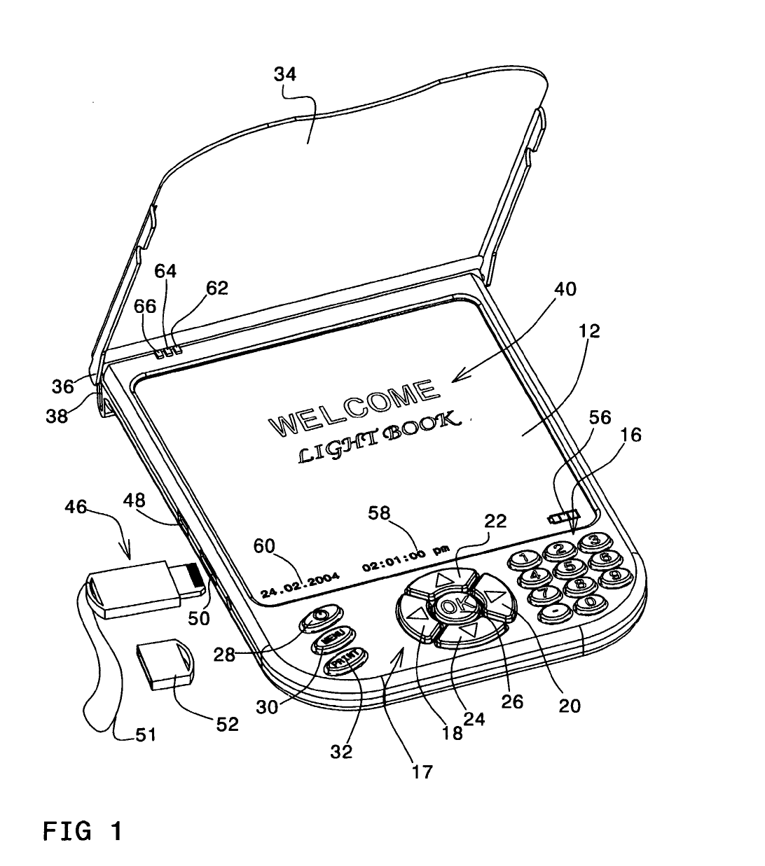

Referring now to FIG. 1, there is shown, a first embodiment of the present invention comprising an electronic book, known herein as the light-book 10 having a visual display screen 12 that is typically a liquid crystal screen or a thin film transistor (tft) array that is preferably full colour, but may however be monochrome. The light-book 10 has a keypad 14 equipped with navigational tools, such as a numeric keypad 16 and Left 18, Right 20, Up 22, Down 24 cursor controls, an OK button 26 for accepting selections or other simple interactions, and other essential or at least useful buttons, such as ON/OFF 28, menu 30 and print 32.

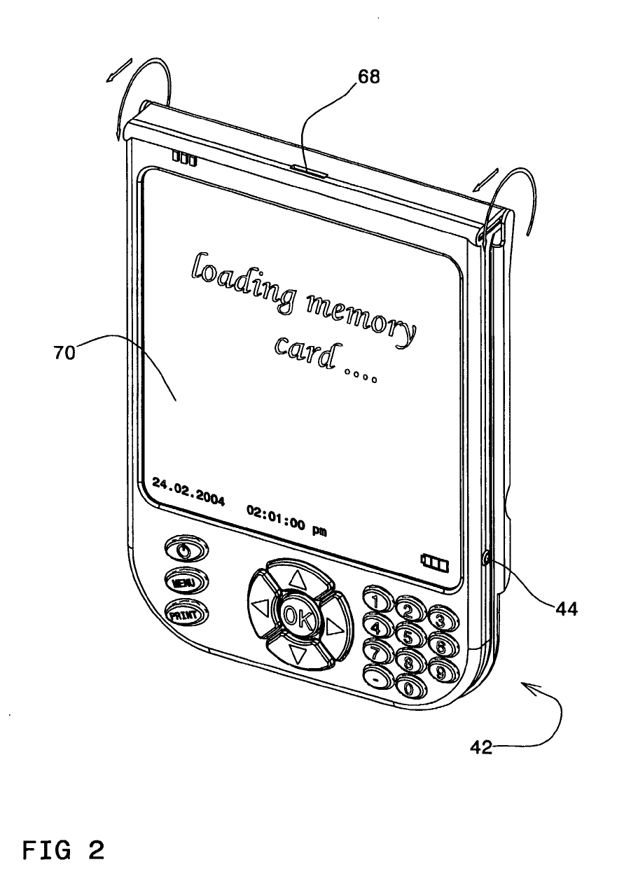

The light-book 10 may include a lid 34 for protecting the screen 12, and possibly also the keypad 14. As illustrated, the lid 34 pivots around a hinge pin 36 within a slot 38, such that the lid 34 may be flipped around the hinge pin 36 from a first position were it covers the face 40 of the light-book 10, to a second position, as shown in FIG. 2, where the lid is positioned behind back 42 of the light-book 10, and optionally and preferably serves as a stand, allowing the light-book to be stood up on a horizontal surface such as a table top, in a substantially vertical position, for ergonomic viewing of the screen 12 thereof, by a user.

The light-book is electrically powered, and typically an internal battery is provided that acts as a power source. Preferably the battery is rechargeable, and a socket 44 (FIG. 2) is provided for connecting the light-book 10 via a DC transformer to an electricity main for recharging. At least in theory, the light-book 10 may be powered directly from an external power source via a power line connected to socket 44. It will be appreciated that the external power source need not be an electricity main; when used whilst traveling; the light-book 10 might be connected to the accumulator of a vehicle for example, either for recharging an internal battery where provided, or for powering the light-book 10.

Data for viewing on the light-book is stored in an external connectable memory within a propriety appendage 46 that is coupleable to the electronic book 10 via a connection that typically comprises a male part 48 on the propriety appendage 46 and a female part or socket 50 on the electronic book 10. The male and female parts 48, 50 of the connector may be a standard USB, or, for an additional layer of security, a unique, proprietary connector.

Preferred embodiments of the light-book 10 will use freely available, open source operating systems and display software, such as LINUX for example, rather than costly E-Book and Windows based systems.

A particular feature of the present invention is that the light-book 10 and the propriety appendage 46 are provided with first and second sections of unique identification code, so that data within the proprietary appendage can only be accessed when the proprietary appendage having a second section of unique identification code is connected to a light-book having a first section of the unique identification code. At its most primitive, the first and second sections of unique identification code may simply be a serial number common to both, or details of the owner/subscriber thereof.

The propriety appendage 46 is typically a small cartridge containing a flash memory, a CDROM, a Write Once Read Many (WORM) memory or similar writeable memory that may or may not be erasable. For convenience, the proprietary appendage may be provided with a protective cover 52 for protecting the connector 48, and with carrying means, such as a strap 54.

In addition to displaying content, the screen 12 may include helpful features such as a battery power indicator, clock 58 and date 60. Generally, the light-book 10 will also be provided with LEDs or other indicators, such as LEDs indicating that the light-book 10 is ON 62 (typically green), that it's dormant 64 (typically orange), that the memory is working 66 (typically red), and so on.

Although the content to be read on the light-book 10 is stored in the memory of a propriety appendage 46, the light-book 10 itself does contain a memory and operating chips including the basic program for running the light-book, for recognizing the presence of a propriety appendage 46 and for reading it, and for storing the first section of the unique identification code, or serial number thereof. A socket 68 (see FIG. 2) is provided, allowing the light-book to be connected to an external programming device for programming it with this basic program, and for updating etc.

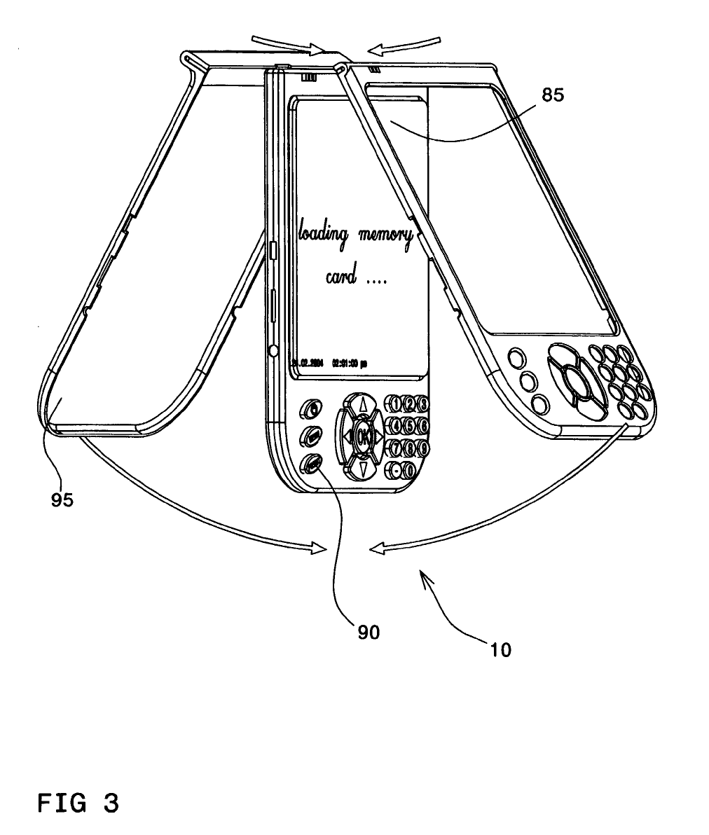

As shown in FIG. 3, the functional components 90 of the light-book 10 are preferably fully and easily separable from the front panel 85 and back panel 95 thereof. In this manner, the casing of the light-book may be replaced allowing the appearance of the light-book to vary enormously, which is an attractive feature for school children for example. It will also be appreciated that this provides a display surface that could be used for advertising purposes and the like.

Typically the screen 12 has a protective transparent scratch resistant laminate thereon to protect it from scratches and the like.

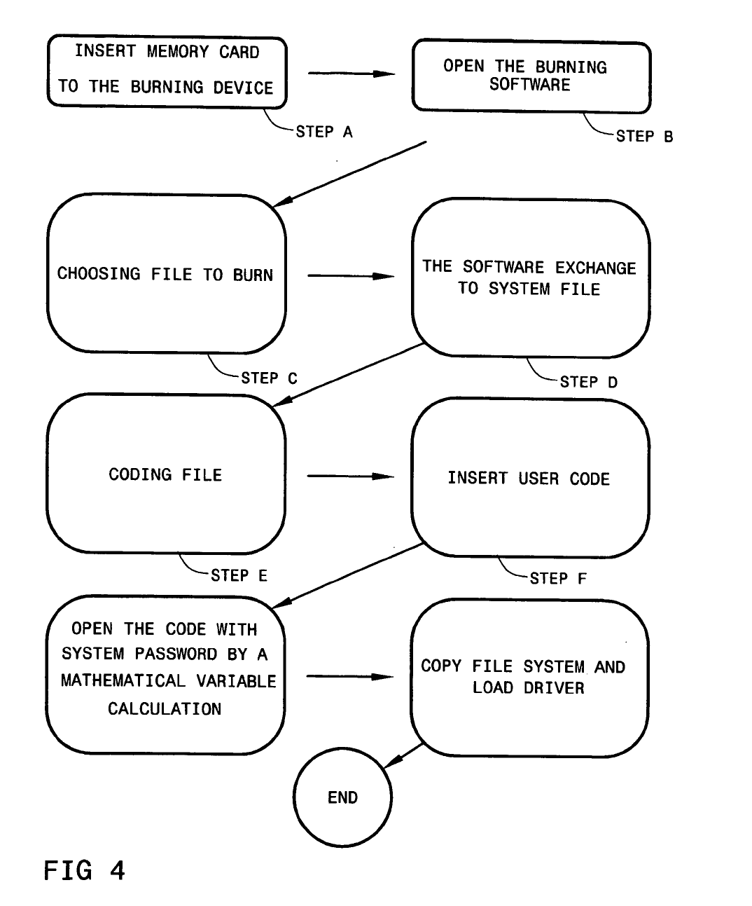

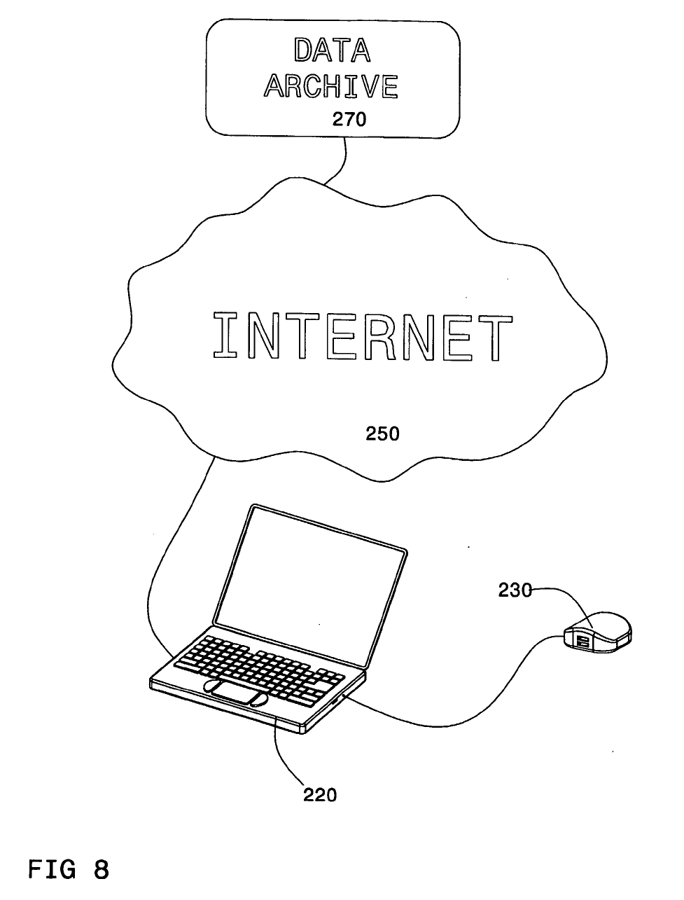

With reference now to FIG. 4, when memory of propriety appendage 46 is a write once read many memory, whether it is a writeable CD-ROM or some sort of memory chip, it may be written or ‘burned’ to load it with content. Such burning is accomplished by a system as shown in FIG. 8, according to a process consisting of the steps of inserting the memory into a burning device or writer coupled to a data archive (step A), initiating the appropriate burning software (step B), selecting desired content file(s) from data archive (step C), adding data protection features (step D) copying of desired content file(s) in data protected form (step E) and adding data protection features (step F) the burned memory may now be replaced into propriety appendage 46 (step 8).

The data archive referred to above, from which selected files are selected, may be a local hard disk, a regular CDROM, or an electronic archive remotely accessed via the Internet. Typically the data is in a standard format such as ASCII, RTF, PDF, GIF or JPEG, for example. The heart of the invention is the addition of data protection features which minimally includes addition of a second section of unique identification code (Step F.1) as described above. Preferably however, there are provided additional levels of protection including a transformation step (step D) for converting the data format into a proprietary, non-standard format, and an encryption step (step E) for encrypting the data. Additionally, in preferred embodiments, the memory, burning device and the reader within the propriety appendage 46 are mutually compatible, non-standard components. Although connector 48 and socket 50 for connecting propriety appendage 46 to light-book 10 may be standard USB connectors, preferably these are also proprietary, unique connector jacks to provide yet another level of protection. Using these features, unlawful reproduction of electronic documents, i.e. copyright piracy, may be prevented.

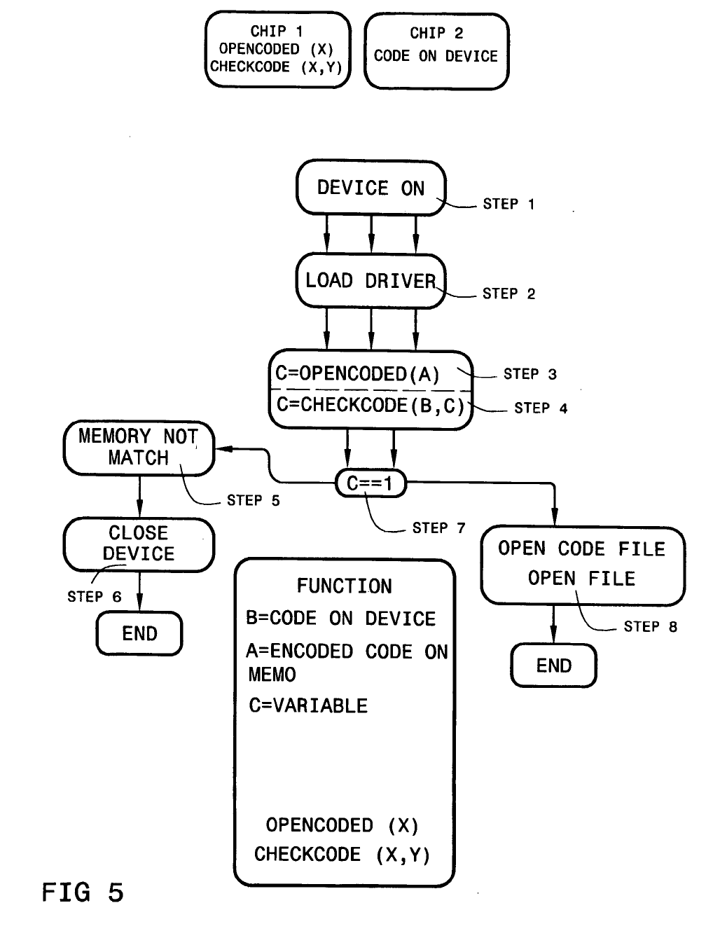

The unique identification code feature described hereinabove also provides data security, preventing unauthorized access to electronic documentation. With further reference to FIG. 5, when light-book 10 is switched on (Step 1), a processing chip 1 therein loads a driver (Step 2) runs a routine that looks for a second chip encoded with a first section of unique identification code. Having found this first section of unique identification code (Step 3) the first chip looks for a proprietary appendage 24 and reads the identification code therein (step 4). If no proprietary appendage 24 is detected, or, if proprietary appendage 24 is detected, but the second section of unique identification code therein is incompatible with the first section of unique identification code (step 5), the light-book closes (Step 6) by switching itself off. If however, there is a compatibility match between the code sections on chip 1 and 2 (step 7), the driver allows data files in proprietary appendage 46 to be accessed and displayed (step 8) by light-book 10.

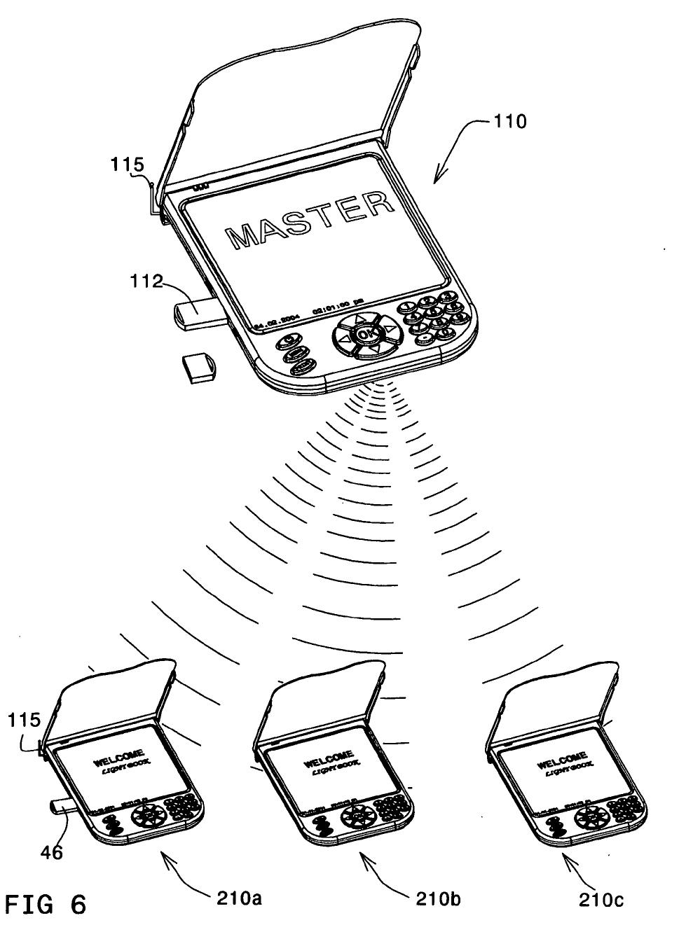

Having disclosed the basic concept of the light-book 10, the man of the art will appreciate that the present invention is capable of several variations and additional features. Thus, with reference to FIG. 6, for example, a ‘master’ light-book 110 having a transmission capability, indicated schematically by a transmitting antenna 115 thereon, might be able to remotely interface with slave light-books 210A-C equipped with receiving antennae 215, allowing a teacher/lecturer to show slides and the like to a number of students, for example. A slave light-book might be a regular electronic book 210A having a proprietary appendage 46 appended thereto, or at least the capability of working as an autonomous unit via a proprietary appendage 46. Alternatively, slave light-books 210B, 210C might be simplified display devices, not having the facility of connection to proprietary appendages, and not having direct data access capability. Such a slave device 210B, 210C will be particularly advantageous within the classroom, as the student is thus unable to use a slave device 210B, 210C to read other material instead of following the lesson. It will be appreciated that the external antennae 115, 215 showed herein, are for illustrating the principle of the master-slave light-book concept. The antennae may be internal. Indeed data may be transferred using any type of data link, preferably cordless, such as by using Bluetooth technology for example.

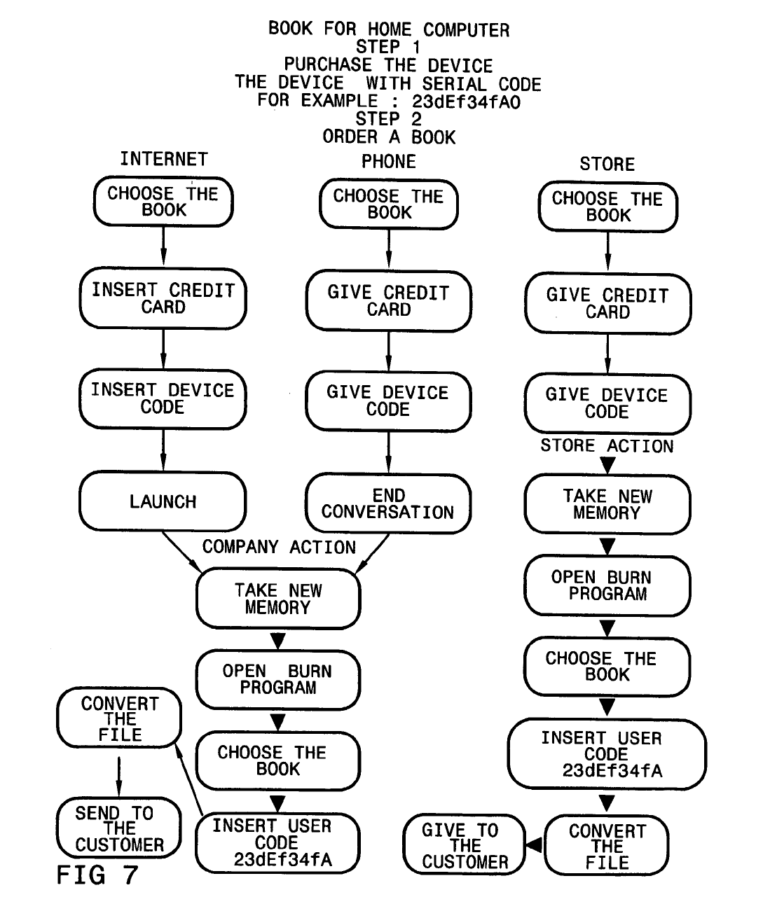

As shown schematically in FIG. 7, the light-book might be ordered by phone, over the Internet or even in a regular store, and, once purchased, the chip 2 therein is burned with the first section of unique identification code providing it with a unique identification, and the processing chip 1 is programmed via socket 68, which may, from time to time, be used for programming the light-book 10 with software updates, improved security features and the like.

Referring now to FIG. 8 there is shown a PC 220 to which a memory writer 230 for burning the writeable memory of a proprietary appendage is coupled. The PC 220 is connected to a data archive 240 via the Internet 250, and allows data within the data archive 240 to be accessed and downloaded to the memory writer 230 for writing onto the writeable memory. The Internet 250 enabled PC 220 illustrated, is, of course, merely one example of a memory writer station, which could be any type of terminal device connected to a data archive and equipped with an appropriate memory writer 230.

By incorporating technology to allow peripheral appendage 48 to be connected to a standard hardware device such as a PC for example, and to load the first section of unique identification code and proprietary decoding and/or transformation software as necessary, it is possible to allow data content within a peripheral appendage 48 to be decrypted and displayed on the standard hardware device but not saved thereon. In this manner, a regular PC may be (temporarily) retroconverted into a light-book 10.

A main application of the light-book, as explained hereinabove, is to serve as a replacement for conventional textbooks for high school and college students, for example. The advantages of electronic books in general and light-books in particular, over the conventional pile of textbooks, are many. Electronic books is more compact and lightweight than conventional piles of school books. It is easier for the pupil to make sure that he is equipped for school or homework, as all the textbook material is in one compact device. Since printing is avoided, the electronic book is environmentally friendly, avoiding deforestation and water pollution associated with paper manufacture. Electronic information enables animations, interactive presentations and the other aspects of multimedia, providing a more interesting learning experience than that obtainable using conventional printed textbooks. Since the information contained therein is in electronic format, it can be updated cheaply and conveniently, and in general, electronic textbooks will be more up to date than printed ones. Thus, by having study material being available in downloadable electronic form from a ministry approved website, for example, not only may royalties by collected, but the list of approved material and the authorized materials themselves may be updated much faster than traditional hardcopy books. Since expensive printing is avoided, costs per ‘book’ can be kept low, and a large proportion of the retail price of updates or of the electronic textbook itself can go to the copyright holder, typically the author and/or education ministry, and not to publishing houses, printers, etc. Schools and the like can provide vending outlets without dedicating the large storage spaces required for stockpiling stacks of textbooks, and the pupil can obtain textbooks and updates on campus, without having to go shopping elsewhere.

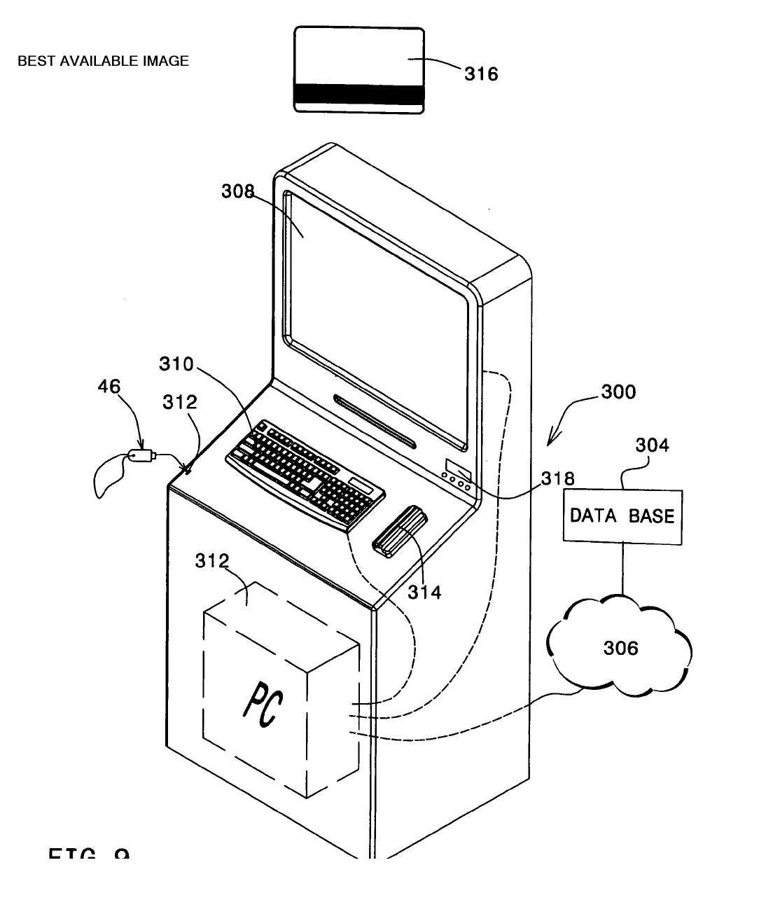

As shown in FIG. 9, a vending outlet 300 will typically include a computer 302 connected to a database 304 of study material including electronic textbooks, for example, preferably over a dedicated network 306 or possibly located in a secure part of the internet. The vending outlet 300 will include a screen 308 and control buttons 310 enabling user interaction therewith, and a socket 312 for accepting a proprietary appendage 46 of the light-book. The vending outlet may include a facility for accepting payment 314, such as a magnetic credit card reader for reading dedicated cards 316 containing details of student or other user, details of the specific user electronic book and payment method. This or an additional card reader may, of course, simply accept credit or debit cards, or a dedicated card may be provided that itself includes an ‘allowance’ for making payments, such a debit card perhaps being a student card that serves other functions such as allowing purchases in cafetarias, use of photocopying machines, serving as a library card, as a student identity card for identifying exam takers and as proof of student status for obtaining discounts on buses, at cinemas, museums and theatres, for example. The vending outlet 300 may include a biometric reader 318 for reading fingerprints or other physical identifying characteristic of the student. Generally the vending outlet 300 will look like a cash vending machine or similar, and be a fairly compact piece of equipment, perhaps built into a wall.

Preferably the dedicated vending outlet 300 also enables updating the proprietary appendages 46 and/or light-books themselves, with updated operating systems, additional features and the like.

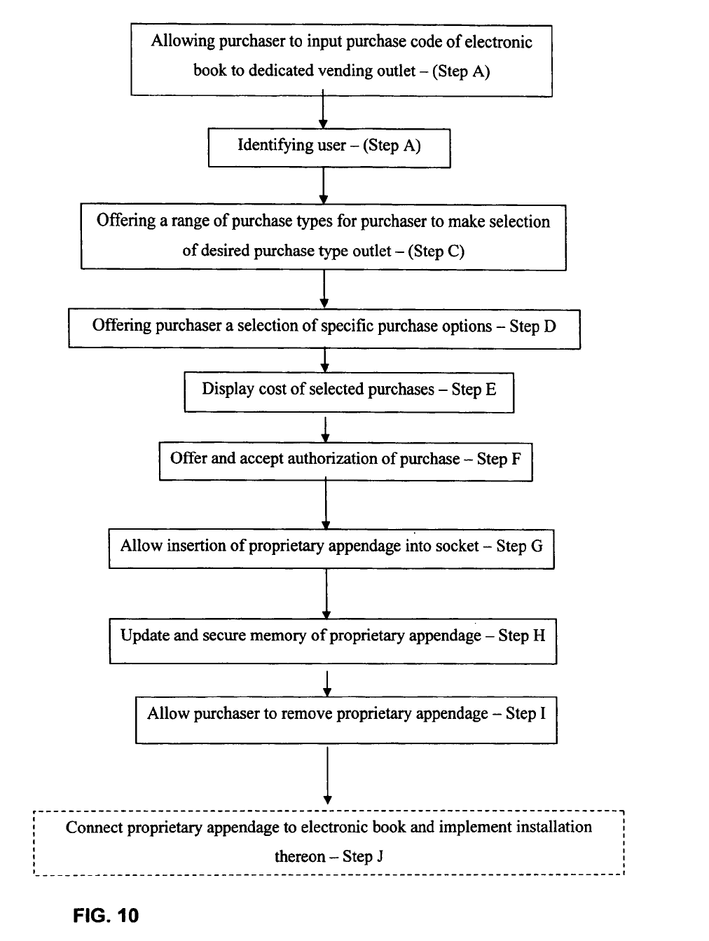

Still referring to FIG. 9, and with additional reference to FIG. 10, the present invention provides a novel method for allowing purchase of study material via the dedicated vending outlet 300 comprising the steps of:

Allowing purchaser to input purchase code of a light-book 10 (FIG. 1) to dedicated vending outlet 300 (Step A), via control buttons 312 of dedicated vending outlet 300, or by swiping a magnetic card 316 through a magnetic card reader 314; identifying user (Step B) perhaps via his signature or via a biometric identification means such as a fingerprint reader 318 or an iris identifier, for example; offering a range of purchase types such as purchase of study material, purchase of upgrade of study material or purchase of upgrade of electronic book 10 to purchaser or user by displaying options on screen 308 (Step C); offering purchaser a selection of specific purchase options such as units of study material chosen from a list of study materials, updates for a unit of study material already installed, chosen from a list of updates, or perhaps an upgrade for the light-book 10 itself (Step D); displaying cost of selected purchases on screen 308 (Step E); offering and accept authorization of purchase (Step F); allowing insertion of proprietary appendage 46 into socket 312 (Step G); updating and securing memory of proprietary appendage 46 (Step H) and allowing purchaser to remove proprietary appendage 46 (Step I). To complete installation, it is generally necessary for the purchaser to perform the additional step of connecting proprietary appendage 46 to the light-book 10 to be updated and implementing installation thereon (Step J).

Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A system comprising an electronic book and a propriety appendage couplable to said electronic book; said electronic book comprising a visual display screen, a data reader, navigational tools and a first section of a unique identification code for identifying said electronic book,
Said propriety appendage comprising a memory and a second section of unique identification code;
such that data in memory of proprietary appendage having second section of unique identification code can only be accessed when proprietary appendage is connected to an electronic book having first section of unique identification code.

2. The system of claim 1 wherein said proprietary appendage is couplable to said electronic book via a USB connector.

3. The system of claim 1, wherein said data in said memory, once written is readable only.

4. The system of claim 1, wherein said data in memory of proprietary appendage is encrypted by a proprietary encrypting algorithm.

5. The system of claim 1, wherein said data in said memory of proprietary appendage is only accessible by using proprietary software only available to authorized electronic books.

6. The electronic book of claim 1, further comprising a processing chip having a routine hardwired therein, said routine for checking for presence of first section of unique identification code within said electronic book and second section of unique identification code within said proprietary appendage, and only after detecting presence of both, and their mutual inter-compatibility, allows access to data stored within said proprietary appendage.

7. The system of claim 1 wherein said electronic book is a personal computer, first section of unique identification code is a unique serial number of said personal computer, and said proprietary appendage is equipped with a second section of unique identification code that is said unique serial number of said personal computer.

8. An electronic book comprising a visual display screen, a data reader, navigational tools and a first section of a unique identification code for identifying said electronic book, said electronic book for use with a propriety appendage comprising a memory and a second section of unique identification code, such that data in memory of proprietary appendage having second section of unique identification code can only be accessed when proprietary appendage is connected to an electronic book having first section of unique identification code.

9. A propriety appendage comprising a memory and a second section of unique identification code for use with an electronic book comprising a visual display screen, a data reader, navigational tools and a first section of a unique identification code for identifying said electronic book,
such that data in memory of proprietary appendage having second section of unique identification code can only be accessed when proprietary appendage is connected to an electronic book having first section of unique identification code.

10. A dedicated vending outlet comprising:
a display screen, control buttons, a facility for accepting payment, a socket, a link to a remote database and burning software;
Said display screen for displaying options to a user;
Said control buttons for enabling said user to toggle displays on said display screen, to place order and optionally to select payment means;
said socket for accepting a proprietary appendage of an electronic book as claimed in claim 1;
said link for downloading of data from remote database and said burning software for writing said data to said proprietary appendage.

11. The dedicated vending outlet of claim 10 further comprising a biometric reader for reading a physical identifying characteristic of the user.

12. The dedicated vending outlet of claim 10 further comprising a magnetic card reader for reading a magnetic card containing details of said user, user's electronic book, purchasing allowance and payment method.

13. The dedicated vending outlet of claim 10 configured to resemble a cash vending machine.

14. The dedicated vending outlet of claim 10 being situated on a college campus or within a school.

15. The dedicated vending outlet of claim 10 for vending data including study material.

16. The dedicated vending outlet of claim 10 for enabling updating of said proprietary appendage and/or said electronic book.

17. A method allowing purchase of study material via a dedicated vending outlet of claim 10 comprising the steps of:
(a) Allowing purchaser to input purchase code of electronic book to dedicated vending outlet;
(b) Identifying user;
(c) Offering a range of purchase types offered for purchaser to make selection of desired purchase type;
(d) Offering purchaser a selection of specific purchase options;
(e) Display cost of selected purchases;
(f) Offer and accept authorization of purchase;
(g) Allow insertion of proprietary appendage into socket;
(h) Update and secure memory of proprietary appendage and
(i) Allow purchaser to remove proprietary appendage.

18. The method of claim 17 for allowing purchase of study material via a dedicated vending outlet comprising an additional step of completing installation, (j) comprising connecting proprietary appendage to electronic book and implement installation thereon.

19. The method of claim 17 wherein said step of the inputting of the purchase code is via control buttons.

20. The method of claim 17 wherein said step of the inputting of the purchase code is by swiping a magnetic card through magnetic card reader.

21. The method of claim 17 wherein said step of identifying a user is via biometric identification means such as fingerprint reader for example.

22. The method of claim 17 wherein said range of purchase types includes purchase of study material and purchase of upgrade of study material previously purchased.

23. The method of claim 17 wherein the specific purchase is selected from the list of (i) units of study material chosen from a list of study materials; (ii) updates for a unit of study material chosen from a list of updates, and (iii) upgrades for said electronic book.
